(19) United States
(12) Patent Application Publication
(10) Pub. No.: US 2023/0202921 A1
(43) Pub. Date: Jun. 29, 2023

(54) CEMENT ADMIXTURE AND CEMENT COMPOSITION

(71) Applicant: DENKA COMPANY LIMITED, Chuo-ku (JP)

(72) Inventors: Taiichiro MORI, Itoigawa-shi (JP); Maho YOSHIOKA, Itoigawa-shi (JP); Daiki SHIMAZAKI, Itoigawa-shi (JP); Noriyuki ARANO, Itoigawa-shi (JP)

(73) Assignee: DENKA COMPANY LIMITED, Chuo-ku (JP)

(21) Appl. No.: 17/996,251

(22) PCT Filed: Apr. 16, 2021
(86) PCT No.: PCT/JP2021/015768

§ 371 Date: Oct. 14, 2022

(30) Foreign Application Priority Data
Apr. 17, 2020 (JP) 2020-074204

(51) Int. Cl. C04B 7/34

(52) U.S. Cl. CPC C04B 7/34

(57) ABSTRACT

A cement admixture containing one kind or two or more kinds of non-hydraulic compound(s) selected from γ-2CaO·SiO₂, 3CaO·2SiO₂, α-CaO·SiO₂, and calcium magnesium silicate, wherein the non-hydraulic compound contains Li, and the content rate of the Li is 0.001 to 1.0% by mass in terms of oxide. Such admixtures may contain, as chemical components, 0.001 to 1.0 parts by mass of Li₂O, 45 to 70 parts by mass of CaO, 30 to 55 parts by mass of SiO₂, and 0 to 10 parts by mass of Al₂O₃ in 100 parts by mass of the cement admixture.

### TECHNICAL FIELD

The present invention relates to a cement admixture and a cement composition used in the civil engineering and architecture fields, etc.

### BACKGROUND ART

Concretes use a large amount of cement as a raw material, and thus are deemed to be materials with a high CO₂ emission amount. This is mainly because a large amount of fossil fuel is used so as to obtain a combustion energy for a furnace, and a decarbonation reaction (CaCO₃→CaO+CO₂) of limestone occurs during the process of the production of a cement. It is an important theme as one of the countermeasures for global warming to decrease CO₂ emission amounts as concretes.

In order to decrease a total amount of CO₂ ejected during the production of concrete products, it is effective to decrease the use amount of a cement by incorporating a large amount of byproduct (a blast furnace slag micropowder, fly ash, etc.) as an alternative of the cement, and various studies are ongoing.

On the other hand, a technique for obtaining a concrete product having high durability in which a surface layer part has been densified by CO₂ absorption by forcedly subjecting a concrete containing a non-hydraulic compound such as γ-C₂S (γ-2CaO·SiO₂; also called a belite γ phase) as an admixture to carbonation curing is known (for example, PTL 1). γ-C₂S does not cause a hydration reaction, and reacts with CO₂ to generate a gel rich in CaCO₃ and SiO₂. These products fill the gaps in a cement matrix, and dramatically improves the durability of the surface layer of the concrete product. In this case, the total CO₂ emission amount in obtaining a concrete product is decreased by the amount of CO₂ absorbed by the concrete in CO₂ carbonation curing.

### CITATION LIST

### Patent Literature

PTL 1: JP 2006-182583 A

### SUMMARY OF INVENTION

### Technical Problem

However, in a high durability concrete in which a non-hydraulic compound such as γ-C₂S is incorporated as shown in PTL 1, it is assumed that a structural body to be aged is disposed in a shielded space capable of maintaining a predetermined carbon dioxide gas concentration. Therefore, in order to make a huge concrete structural body that cannot be housed in an aging equipment as a subject to be aged, a cement admixture that can further accelerate the carbonation of the incorporated non-hydraulic compound is required.

Accordingly, the present invention was made so as to solve the above-mentioned problem, and aims at providing a cement admixture that can promote a carbonation reaction of a non-hydraulic compound in carrying out carbonation curing.

### Solution to Problem

The inventors did intensive studies so as to solve the problem as mentioned above, and consequently found that a cement admixture containing Li obtained by undergoing a thermal treatment process together with a non-hydraulic compound containing Li at a predetermined percentage can solve the above-mentioned problem, and completed the present invention. That is, the present invention is as mentioned below.

[1] A cement admixture containing one kind or two or more kinds of non-hydraulic compound(s) selected from the group consisting of γ-2CaO·SiO₂, 3CaO·2SiO₂, α-CaO·SiO₂, and calcium magnesium silicate, wherein the non-hydraulic compound contains Li, and the content rate of the Li is 0.001 to 1.0% by mass in terms of oxide.

[2] The cement admixture of [1], which contains, as chemical components, 0.001 to 1.0 parts by mass of Li₂O, 45 to 70 parts by mass of CaO, 30 to 55 parts by mass of SiO₂, and 0 to 10 parts by mass of Al₂O₃ in 100 parts by mass of the cement admixture.

[3] The cement admixture of [1] or [2], wherein the content rate of sulfur in the non-hydraulic compound is 1.0% by mass or less in terms of oxide.

[4] The cement admixture of any one of [1] to [3], wherein the content rate of the non-hydraulic compound is 70% by mass or more.

[5] The cement admixture of any one of [1] to [4], wherein the non-hydraulic compound is γ-2CaO·SiO₂.

[6] The cement admixture of any one of [1] to [5], wherein by-produced slaked lime is used as the CaO raw material for the non-hydraulic compound.

[7]A cement composition containing the cement admixture of any one of [1] to [6].

### Advantageous Effects of Invention

According to the present invention, a cement admixture capable of promoting a carbonation reaction of a non-hydraulic compound in carrying out carbonation curing can be provided.

### DESCRIPTION OF EMBODIMENTS

Hereinafter an exemplary embodiment (this embodiment) of the present invention will be explained in detail. Note that the parts and % used in the present specification are based on mass unless otherwise defined.

### [Cement Admixture]

The cement admixture of this embodiment contains one kind or two or more kinds of non-hydraulic compound(s) selected from the group consisting of γ-2CaO·SiO₂, 3CaO·2SiO₂, α-CaO·SiO₂, and calcium magnesium silicate.

Furthermore, the cement admixture of this embodiment further contains Li in the non-hydraulic compound, and the content thereof is 0.001 to 1.0% in terms of oxide. By the Li in this predetermined amount, it is assumed that the generation of vaterite, which is a kind of calcium carbonate of C—S—H (calcium silicate hydrate), and it is considered that a denser cured state can be obtained more easily by carbonation curing.

Here, “contains Li in the non-hydraulic compound” refers to a state in which Li₂O is contained as a chemical composition in the non-hydraulic compound (the presence can be confirmed by ICP luminescence spectroscopy), whereas Li₂O is not identified in X-ray diffractometry, which is not a state in which a non-hydraulic compound and a Li compound are simply physically mixed. Such state can be obtained by mixing the respective raw materials and subjecting the mixture to a thermal treatment at a high temperature of 1,000° C. or more. Hereinafter the respective components, etc. will be explained.

### (γ-2CaO·SiO₂)

γ-2CaO·SiO₂ is known as a low temperature phase among the compounds represented by 2CaO·SiO₂, and are completely different from α-2CaO·SiO₂, α′-2CaO·SiO₂ and β-2CaO·SiO₂, which are high temperature phases. All of these are represented by 2CaO·SiO₂, but have different crystalline structures and densities.

### (3CaO·2SiO₂)

3CaO·2SiO₂ is a mineral containing CaO in pseudowollastonite, and called rankinite. It is a chemically stable mineral having no hydration activity, but has a large carbonation accelerating effect.

### (α-CaO·SiO₂)

α-CaO·SiO₂ (Type a wollastonite) is known as a high temperature phase among compounds represented by CaO·SiO₂, and is completely different from β-CaO·SiO₂, which is a low temperature phase. All of these are represented by CaO·SiO₂, but have different crystalline structures and densities.

Naturally generating wollastonite is β-CaO·SiO₂ of a low temperature phase. β-CaO·SiO₂ has a needle-shaped crystalline and is utilized as an inorganic fibrous substance such as wollastonite fiber, but does not have a carbonation accelerating effect as in α-CaO·SiO₂ of this embodiment.

### (Calcium Magnesium Silicate)

Calcium magnesium silicate is a collective term of CaO—MgO—SiO₂-based compounds, and in this embodiment, Merwinite represented by 3CaO·MgO·2SiO₂ (C₃MS₂) is preferable, and a high carbonation accelerating effect is achieved by Merwinite.

The non-hydraulic compound as mentioned above can be one kind or two or more kinds, and the content rate of Li in said non-hydraulic compound is preferably 0.001 to 1.0%, preferably 0.005 to 1.0%, more preferably 0.010 to 0.90%, further preferably 0.015 to 0.80% in terms of oxide. If the content rate of Li is lower than 0.001% in terms of oxide, a carbonation accelerating effect cannot be obtained. If the content exceeds 1.0%, the cost is high. The content rate of Li in terms of oxide can be measured by the method described in Examples.

Note that in the case where the non-hydraulic compound is two or more kinds, the content rate of Li refers to a content rate of the Li with respect to the total of the two or more kinds of non-hydraulic compounds in terms of oxide.

Among the above-mentioned non-hydraulic compounds, γ-2CaO·SiO₂ is specifically preferable in that it accompanies a powderization phenomenon called dusting during the production, and thus requires a lower energy for pulverizing as compared to other compounds, has a high carbonation accelerating effect for a long time period, whereas it has a very high effect of suppressing neutralization when combined with a blast furnace cement at a low water binder ratio.

The non-hydraulic compound of this embodiment can be obtained by incorporating a CaO raw material, a SiO₂ raw material, a MgO raw material and a Li raw material at a predetermined molar ratio and thermally treating the raw materials. Examples of the CaO raw material include calcium carbonates such as limestone, calcium hydroxides such as slaked lime, and by-produced slaked limes such as acetylene by-produced slaked lime, and micropowders generated from waste concrete masses. Examples of the SiO₂ raw material include various siliceous dusts generated as industrial byproducts represented by, for example, silica stone and clay, as well as silica fume and fly ash. Examples of the MgO raw material can include magnesium hydroxide, basic calcium carbonate and dolomite. Furthermore, examples of the Li raw material can include lithium carbonate. Note that in the case where Li is included in the CaO raw material, the SiO₂ raw material and the MgO raw material, it is not necessary to newly add an Li raw material. From the decreasing of a CO₂ emission amount derived from non-energy during a thermal treatment, one kind or two or more kinds selected from industrial by-products containing CaO such as by-produced slaked lime, micropowders generated from waste concrete masses, municipal waste incinerated ash, and sewage water sludge incinerated ash and industrial byproducts including CaO can be utilized. Among these, use of by-produced slaked lime, which contains a smaller amount of impurity as compared to other industrial byproducts, is further preferable.

Examples of the by-produced slaked lime include acetylene by-produced slaked limes such as by-produced slaked limes (there are a dry product and a wet product based on the difference of the method for producing acetylene gas), which are by-produced by the method for producing acetylene gas by the calcium carbide process, and by-produced slaked lime contained in dusts captured by a wet dust collection step of a calcium carbide electric furnace. The by-produced slaked lime includes, for example, 65 to 95% (preferably 70 to 90%) of calcium hydroxide, and 1 to 10% of calcium carbonate, and 0.1 to 6.0% (preferably 0.1 to 3.0%) of iron oxide. The percentages of these can be confirmed by a mass decrease obtained by fluorescence X-ray measurement, and differential thermal gravimetry (TG-DTA) (Ca(OH)₂: around 405° C. to 515° C., CaCO₃: around 650° C. to 765° C.). A volume average particle size measured by laser diffraction and scattering method is about 50 to 100 μm. Furthermore, in JIS K 0068 “Method for Measuring Water Content in Chemical Product”, a water content rate measured by the loss on drying method is preferably 10% or less. Furthermore, sulfur compounds such as CaS, Al₂O₃ and CaC₂·CaS can be contained, but they are preferably 2% or less.

The thermal treatment at a high temperature of 1,000° C. or more as already mentioned above is not specifically limited, and can be carried out by, for example, a rotary kiln or an electric furnace. The thermal treatment temperature is not unambiguously defined, but is generally carried out in a range of about 1,000 to 1,800° C., and carried out in a range of about 1,200 to 1,600° C. in many cases.

This embodiment can also use an industrial byproduct containing the non-hydraulic compound as already mentioned above. In this case, an impurity co-exists. Examples of such industrial byproduct include steel slag, etc.

The CaO raw material, SiO₂ raw material and MgO raw material can contain an impurity, but it is not specifically a problem in a scope where the effect of the present invention is not inhibited. Specific examples of the impurity include Al₂O₃, Fe₂O₃, TiO₂, MnO, Na₂O, K₂O, S, P₂O₅, F, B₂O₃, and chlorine. Furthermore, examples of the co-existing compound include free calcium oxide, calcium hydroxide, calcium aluminate, calcium aluminosilicate, calcium ferrite and calcium aluminoferrite, calcium phosphate, calcium borate, magnesium silicate, leucite (K₂O,Na₂O)·Al₂O₃SiO₂, spinel MgO·Al₂O₃, magnetite Fe₃O₄, and the above-mentioned sulfur compounds such as CaS, Al₂O₃ and CaC₂·CaS.

Of these impurities, the content rate of S (sulfur) in the non-hydraulic compound is preferably 1.0% or less, more preferably 0.7% or less, further preferably 0.5% or less in terms of oxide (SO₃). By being 1.0% or less, a sufficient carbonation accelerating effect can be obtained, and condensation and curing characteristics can be set to be in appropriate ranges. The content rate of S in terms of oxide (SO₃) can be measured by fluorescence X-ray measurement. Note that the S (sulfur) in the non-hydraulic compound can be present as long as it is about 2% in terms of oxide.

In this admixture, the content rate of the non-hydraulic compound (the case where plural kinds are contained, the content rate to the total amount) is preferably 65% or more, more preferably 70% or more, further preferably 75% or more. Note that hydraulic 2CaO·SiO₂ other than γ-2CaO·SiO₂ can be admixed, and can be admixed up to 35% at the maximum.

The content rate of γ-2CaO·SiO₂ in this admixture is preferably 35% or more, more preferably 45% or more. Furthermore, the upper limit value of the upper limit value of γ-2CaO·SiO₂ is not specifically limited. Among steel-making slags, an electric furnace reduction period slag or a stainless slag with a large content rate of γ-2CaO·SiO₂ is preferable.

Furthermore, in this admixture, from the viewpoint of easier expression of the effect, it is preferable to contain 0.001 to 1.0 parts of Li₂O, 45 to 70 parts of CaO, 30 to 55 parts of SiO₂, and 0 to 10 parts of Al₂O₃ as chemical components in 100 parts of the cement admixture. The content of Li₂O can be measured by the method described in the following Examples. Furthermore, CaO, SiO₂ and Al₂O₃ can be measured by fluorescence X-ray.

As the chemical components, it is preferable to contain 0.002 to 0.5 parts of Li₂O, 60 to 70 parts of CaO, 30 to 45 parts of SiO₂ and 0.5 to 5 parts of Al₂O₃ in 100 parts of the cement admixture.

Furthermore, as the chemical component, the total of Li₂O, CaO, SiO₂ and Al₂O₃ is preferably 90 parts or more, more preferably 95 to 100 parts in 100 parts of the cement admixture.

The method for quantifying the non-hydraulic compound in this admixture can include the Rietveld method by powder X-ray diffractometry.

The Blaine specific surface area of this admixture is not specifically limited, and is preferably 1,500 cm²/g or more, and the upper limit is preferably 8,000 cm²/g or less. Among these, 2,000 to 6,000 cm²/g is more preferable, and 4,000 to 6,000 cm²/g is the most preferable. Since the Blaine specific surface area is 2,000 cm²/g or more, a fine material separation resistance can be obtained, and the carbonation accelerating effect becomes sufficient. Furthermore, by being 8,000 cm²/g or less, the pulverizing power in pulverization does not increase and thus the method is cost efficient, and weathering is suppressed and the deterioration over time of the quality can be suppressed.

### [Cement Composition]

The cement composition of this embodiment contains the cement admixture of the present invention.

The use amount of the cement admixture is not specifically limited, and generally, it is preferably 5 to 80 parts, more preferably 5 to 50 pars, and further preferably 10 to 40 parts in total 100 parts of the cement and this admixture. By being 5 parts or more, hydration heat can be decreased, and by being 80 parts or less (specifically 50 parts or less), the strength expressing property becomes fine.

The use amount of water with respect to the cement composition of this embodiment is not specifically limited, and a generally used range is used. Specifically, the amount of water with respect to 100 parts of the cement and this admixture in total is preferably 25 to 60 parts. By being 25 parts or more, a sufficient workability can be obtained, and by being 60 parts or less, the strength expression and carbonation accelerating effects can be made sufficient.

Note that, in order to correspond to 32.5 N/mm² specification by using this cement admixture, it is sufficient to admix about 10 to 20 parts of this cement admixture in 100 parts of this cement admixture irrespective of the kind of the non-hydraulic compound, and in order to correspond to a 42.5 N/mm² specification product class, it is sufficient to admix about 20 to 35 parts in 100 parts of this cement admixture.

The cement used in the cement composition of this embodiment is not specifically limited, those containing a Portland cements are preferable, and examples include a variety of Portland cements such as normal Portland cement, early strength Portland cement, super-early strength Portland cement, low-heat Portland cement, and moderate-heat Portland cement. Furthermore, examples can also include a variety of mixed cements of those Portland cements admixed with blast-furnace slag, fly ash or silica, waste-utilizing cements produced by using municipal waste incineration ash or sewage water sludge incineration ash as a raw material, so-called Eco-Cements®, and filler cements mixed with a limestone powder. Furthermore, examples can also include geopolymer cements, sulfoaluminate cements, limestone calcination clay cements (LC3), which emit CO₂ in a smaller amount than that of conventional cements. One kind or two or more kinds of these can be used.

The cement composition of this embodiment is beneficial to blast furnace cements and Eco-Cements, for which suppression of neutralization is strongly demanded at a low water binder ratio, and specifically, it is the most preferable to use in combination with a blast furnace cement.

The granularity of the cement composition of this embodiment is not specifically limited since it depends on the intended purpose and use, generally, it is preferably 2,500 to 8,000 cm²/g, more preferably 3,000 to 6,000 cm²/g by a Blaine specific surface area. By being 2,500 cm²/g or more, the strength expression property can be sufficiently obtained, and by being 8,000 cm²/g or less, the workability can be improved.

In the cement composition of this embodiment, besides the cement and the present admixture, one kind or two or more kinds of known and publicly-used additives or admixtures used in general cement materials such as aggregates such as sand and gravel, granulated blast furnace slag fine powders, blast furnace slow-cooled slag powders, limestone fine powders, fly ash, and admixture materials such as silica fume, and natural pozzolans such as volcanic ash, expanders, rapid hardeners, water reducers, AE water reducers, high-performance water reducers, high-performance AE reducers, defoamers, thickeners, rust inhibitors, anti-freeze agents, shrinkage reducers, polymers, condensation regulators, clay minerals such as bentonite, and anionic exchangers such as hydrotalcite can be used in a range in which the object of the present invention is not substantially inhibited.

The cement composition of this embodiment can be prepared by mixing the respective materials at the time of construction, or it is allowed to mix part or entirety in advance. Furthermore, the method for mixing the respective materials and water is also not specifically limited, and the respective materials can be mixed at the time of construction, or it is allowed to mix part or entirety in advance. Alternatively, part of the material can be mixed with water and then the residual material can be mixed.

As the mixing apparatus, any existing apparatus can be used, and for example, a tilting mixer, an omni mixer, a Henschel mixer, a Type-V mixer and a Nauta mixer can be used.

### EXAMPLES

Hereinafter the present invention will further be explained in detail by using Examples and Comparative Examples. However, the present invention is not limited to the following Examples as long as it deviates the gist thereof.

### Experimental Example 1

### (1) Preparation of Cement Admixture

Cement admixtures A to D were prepared as follows.

Cement admixture A: Li-containing γ-2CaO·SiO₂. Calcium carbonate of reagent-grade 1 and silicon dioxide of reagent-grade 1 were mixed at a molar ratio of 2:1, and lithium carbonate of reagent-grade 1 was further mixed so that the content of Li with respect to the mixture became 0.1% (internal replacement) in terms of oxide (Li₂O), and the mixture was thermally treated at 1,400° C. for 2 hours, and left to room temperature to prepare Cement admixture A having a Blaine specific surface area of 4,000 cm²/g.

Cement admixture B: Li-containing 3CaO·2SiO₂. Calcium carbonate of reagent-grade 1 and silicon dioxide of reagent-grade 1 were mixed at a molar ratio of 3:2, and lithium carbonate of reagent-grade 1 was further mixed so that the content of Li with respect to the mixture became 0.1% (internal replacement) in terms of oxide (Li₂O), and the mixture was thermally treated at 1,400° C. for 2 hours, and left to room temperature to prepare Cement admixture B having a Blaine specific surface area of 4,000 cm²/g.

Cement admixture C: Li-containing α-CaO·SiO₂. Calcium carbonate of reagent-grade 1 and silicon dioxide of reagent-grade 1 were mixed at a molar ratio of 1:1, and lithium carbonate of reagent-grade 1 was further mixed so that the content of Li with respect to the mixture became 0.1% (internal replacement) in terms of oxide (Li₂O), and the mixture was thermally treated at 1,500° C. for 2 hours, and left to room temperature to prepare Cement admixture C having a Blaine specific surface area of 4,000 cm²/g.

Cement admixture D: Li-containing 3CaO·MgO·2SiO₂. Calcium carbonate of reagent-grade 1, magnesium oxide of reagent-grade 1, and silicon dioxide of reagent-grade 1 were mixed at a molar ratio of 3:1:2, and lithium carbonate of reagent-grade 1 was further mixed so that the content of Li with respect to the mixture became 0.1% (internal replacement) in terms of oxide (Li₂O), and the mixture was thermally treated at 1,400° C. for 2 hours, and left to room temperature to prepare Cement admixture D having a Blaine specific surface area of 4,000 cm²/g.

Cement admixture E: β-2CaO·SiO₂. Calcium carbonate of reagent-grade 1 and silicon dioxide of reagent-grade 1 were mixed at a molar ratio of 2:1, and the mixture was thermally treated at 1,400° C. for 2 hours, left to room temperature and pulverized, and similar thermal treatments were repeated until the peak of γ-2CaO·SiO₂ was not confirmed by XRD. After a peak of only β-2CaO·SiO₂ was confirmed, Cement admixture E having a Blaine specific surface area of 4,000 cm²/g was prepared.

Cement admixture F: γ-2CaO·SiO₂. Calcium carbonate of reagent-grade 1 and silicon dioxide of reagent-grade 1 were mixed at a molar ratio of 2:1, and the mixture was thermally treated at 1,400° C. for 2 hours, left to room temperature, whereby γ-2CaO·SiO₂ having a Blaine specific surface area of 4,000 cm²/g was prepared.

Cement admixture G: Li₂O+γ-2CaO·SiO₂. Calcium carbonate of reagent-grade 1 and silicon dioxide of reagent-grade 1 were mixed at a molar ratio of 2:1, and the mixture was thermally treated at 1,400° C. for 2 hours, left to room temperature, whereby γ-2CaO·SiO₂ having a Blaine specific surface area of 4,000 cm²/g was prepared.

Furthermore, lithium carbonate of reagent-grade 1 was thermally treated at 1,400° C. for 2 hours, and left to room temperature to prepare a Li₂O powder.

A Li₂O powder (lithium carbonate of reagent-grade 1 thermally treated at 1,400° C. for 2 hours) was internally mixed with γ-2CaO·SiO₂ so that Li₂O was set to 0.1% (internal replacement) to prepare Cement admixture G.

Note that the Li content in terms of oxide in each cement admixture was measured by an ICP luminescence spectrometer (VISTA-PRO manufactured by Hitachi High-Tech Science Corporation). Furthermore, it was confirmed that the Li content was similar to the charged amount by an absolute calibration curve method using a diluted mixed solution for XSTC-22 ICP by SPEX Industries Inc. Note that the measurement conditions are as mentioned below.
Li measured wavelength: 670.783 nm
BG correction: fitting curve method
Standard solution for calibration curve: a mixed solution for XSTC-22 ICP by SPEX Industries Inc, was diluted and used
   Calibration curve range: a five-point calibration curve of 0-5 mg/L (0 mg/L, 0.1 mg/L, 0.5 mg/L, 1 mg/L, 5 mg/L)
Quantified by absolute calibration curve method

### (2) Evaluation of Carbonation Reaction Rate of Admixture

Five grams of each admixture was weighed in an evaporating basin, and subjected to carbonation curing in accordance with JIS A 1153 for 7 days (room temperature: 20° C., relative humidity: 60%, 5%-CO₂ concentration). After the carbonation curing for 7 days, thermogravimetry (TO) was carried out using differential thermogravimetry (manufactured by NETZSCH, Type 2020SA), at a sample weight of 50±2 mg, and a temperature raising velocity of 10° C./min from room temperature to 1,000° C. under a nitrogen flow environment. The CaCO₃ generation amount (carbonation reaction rate) was obtained by calculating the decreased amount around 650° C. to 765° C. in the TG curve as the decreased amount by the decarbonation of CaCO₃. The results are shown in Table 1.

Carbonation reaction rate (%)=[Δm_{CaCO3}/(m₀−m_{1,000})]×100.09/44.01×100

In the equation, Δm_{CaCO3}: decarbonation amount of calcium carbonate (mg), m₀: amount of sample used for measurement (mg), m_{1,000}: amount of decrease of mass up to 1,000° C. (mg)

### (3) Measurement of Vaterite Amount by XRD Measurement

The measurement was carried out by Powder X-ray diffraction (manufactured by Rigaku Corporation, SmartLab). An internal standard substance such as aluminum oxide or magnesium oxide was added to a cement admixture at a predetermined amount, the mixture was sufficiently mixed in an agate mortar, and powder X-ray diffractometry was then carried out. The measurement result was analyzed by quantification software, and a vaterite content was obtained. As the quantification software, “SmartlabStudio II” manufactured by Rigaku Corporation was used. The results are shown in Table 1.

TABLE 1

| | | Evaluation of | | |
|---|---|---|---|---|
| | | carbonation | Amount of | |
| | | reaction rate | vaterite | |
| | | (%) | (%) | Remarks |
| Admixture A | γ-2CaO•SiO₂ | 31.2 | 8.8 | Example |
| | Li (in terms of oxide): 0.1% | | | |
| Admixture B | 3CaO•2SiO₂ | 30.7 | 9.3 | Example |
| | Li (in terms of oxide): 0.1% | | | |
| Admixture C | α-2CaO•SiO₂ | 30.6 | 7.1 | Example |
| | Li (in terms of oxide): 0.1% | | | |
| Admixture D | 3CaO•MgO•2SiO₂ | 30.1 | 7.3 | Example |
| | Li (in terms of oxide): 0.1% | | | |
| Admixture E | β-2CaO•SiO₂ | 25.0 | 0.7 | Comparative |
| | | | | Example |
| Admixture F | γ-2CaO•SiO₂ | 25.0 | 3.8 | Comparative |
| | | | | Example |
| Admixture G | Li₂O + | 25.0 | 4.2 | Comparative |
| | γ-CaO•SiO₂ | | | Example |

### Experimental Example 2

Cement admixtures A-1 to A-7 and Cement admixtures C-1 to C-7 were prepared in similar manners to the preparations of Cement admixture A and Admixture C in Experiment 1, except that the lithium carbonate of reagent-grade 1 was mixed in the respective preparations of Cement admixture A and Admixture C of Experiment 1 so that the content rate of Li to the mixture became 0.0005%, 0.002%, 0.006%, 0.1%, 0.15%, 0.8%, 0.9%, 1.0%, 1.1% in terms of oxide (Li₂O) (internal replacement each). Similar evaluations to that for Experiment 1 were carried out for the respective cement admixtures. The results are shown in Table 2.

TABLE 2

| | | Evaluation of | | |
|---|---|---|---|---|
| | | carbonation | Amount of | |
| | | reaction rate | vaterite | |
| | | (%) | (%) | Remarks |
| Admixture A-0 | γ-2CaO•SiO₂ | 24.1 | 3.3 | Comparative |
| | Li (in terms of oxide): 0.0005% | | | Example |
| Admixture A-1 | γ-2CaO•SiO₂ | 30.1 | 4.4 | Example |
| | Li (in terms of oxide): 0.002% | | | |
| Admixture A-2 | γ-2CaO•SiO₂ | 30.9 | 7.5 | Example |
| | Li (in terms of oxide): 0.006% | | | |
| Admixture A | γ-2CaO•SiO₂ | 31.2 | 8.8 | Example |
| | Li (in terms of oxide): 0.10% | | | |
| Admixture A-3 | γ-2CaO•SiO₂ | 30.9 | 9.1 | Example |
| | Li (in terms of oxide): 0.15% | | | |
| Admixture A-4 | γ-2CaO•SiO₂ | 30.7 | 9.3 | Example |
| | Li (in terms of oxide): 0.80% | | | |
| Admixture A-5 | γ-2CaO•SiO₂ | 30.5 | 9.2 | Example |
| | Li (in terms of oxide): 0.90% | | | |
| Admixture A-6 | γ-2CaO•SiO₂ | 30.3 | 8.9 | Example |
| | Li (in terms of oxide): 1.0% | | | |
| Admixture A-7 | γ-2CaO•SiO₂ | 23.6 | 3.1 | Comparative |
| | Li (in terms of oxide): 1.1% | | | Example |
| Admixture C-0 | α-CaO•SiO₂ | 23.9 | 3.1 | Comparative |
| | Li (in terms of oxide): 0.0005% | | | Example |
| Admixture C-1 | α-CaO•SiO₂ | 30.0 | 4.5 | Example |
| | Li (in terms of oxide): 0.002% | | | |
| Admixture C-2 | α-CaO•SiO₂ | 30.7 | 7.4 | Example |
| | Li (in terms of oxide): 0.006% | | | |
| Admixture C | α-CaO•SiO₂ | 30.6 | 7.1 | Example |
| | Li (in terms of oxide): 0.10% | | | |
| Admixture C-3 | α-CaO•SiO₂ | 31.0 | 9.0 | Example |
| | Li (in terms of oxide): 0.015% | | | |
| Admixture C-4 | α-CaO•SiO₂ | 30.5 | 9.2 | Example |
| | Li (in terms of oxide): 0.80% | | | |
| Admixture C-5 | α-CaO•SiO₂ | 30.3 | 8.9 | Example |
| | Li (in terms of oxide): 0.90% | | | |
| Admixture C-6 | α-CaO•SiO₂ | 30.2 | 9.0 | Example |
| | Li (in terms of oxide): 1.0% | | | |
| Admixture C-7 | α-CaO•SiO₂ | 23.8 | 3.1 | Comparative |
| | Li (in terms of oxide): 1.1% | | | Example |

### Experimental Example 3

Cement admixtures A-8 to A-11 and Cement admixtures C-8 to C-11 were prepared in similar manners to the preparations of Cement admixture A and Admixture C in Experiment 1, except that the calcium sulfate of reagent-grade 1 was mixed in the respective preparations of Cement admixture A and Admixture C of Experiment 1 so that the content rate of sulfur became 0.5%, 0.8%, 1.0%, 1.5% in terms of oxide. Similar evaluations to that of Experiment 1 were carried out for the respective cement admixtures. The results are shown in Table 3.

TABLE 3

| | | Evaluation of | | |
|---|---|---|---|---|
| | | carbonation | Amount of | |
| | | reaction rate | vaterite | |
| | | (%) | (%) | Remarks |
| Admixture A | γ-2CaO•SiO₂ | 31.2 | 8.8 | Example |
| | Sulfur (in terms of oxide): 0% | | | |
| Admixture A-8 | γ-2CaO•SiO₂ | 30.7 | 7.1 | Example |
| | Sulfur (in terms of oxide): 0.5% | | | |
| Admixture A-9 | γ-2CaO•SiO₂ | 30.7 | 7.1 | Example |
| | Sulfur (in terms of oxide): 0.8% | | | |
| Admixture A-10 | γ-2CaO•SiO₂ | 30.7 | 7.1 | Example |
| | Sulfur (in terms of oxide): 1.0% | | | |
| Admixture A-11 | γ-2CaO•SiO₂ | 30.4 | 5.9 | Example |
| | Sulfur (in terms of oxide): 1.5% | | | |
| Admixture C | α-CaO•SiO₂ | 30.6 | 7.1 | Example |
| | Sulfur (in terms of oxide): 0% | | | |
| Admixture C-8 | α-CaO•SiO₂ | 29.9 | 5.1 | Example |
| | Sulfur (in terms of oxide): 0.5% | | | |
| Admixture C-9 | α-CaO•SiO₂ | 29.8 | 5.0 | Example |
| | Sulfur (in terms of oxide): 0.8% | | | |
| Admixture C-10 | α-CaO•SiO₂ | 29.8 | 5.1 | Example |
| | Sulfur (in terms of oxide): 1.0% | | | |
| Admixture C-11 | α-CaO•SiO₂ | 29.2 | 3.8 | Example |
| | Sulfur (in terms of oxide): 1.5% | | | |

### Experimental Example 4

Admixture A or Admixture A-1, or Admixture C or Admixture C-1 was each mixed by 25 parts with respect to 100 parts of a cement to give a cement composition, and a mortal sample was prepared in accordance with JISR 5201 so that the water/cement composition ratio became 50% and the ratio of the cement composition to sand became 1:3 (mass ratio). After form removal at the age of 1 day, accelerated carbonation curing was carried out to each age shown in Table 4 under an environment of a temperature of 20° C., a relative humidity of 50% and a CO₂ concentration of 20%, and a condensation time, a compression strength and a length variation rate (carbonation time: 243 days, and the age was 250 days including 7 days of curing in water). The results are shown in the following Table 4.

Note that the summary of the respective materials is as mentioned below.
Cement: normal Portland cement, manufactured by Denka Company Ltd., specific gravity: 3.15, Blaine specific surface area: 3,300 cm²/g.
Water: tap water
Sand: JIS standard sand

### <Evaluation Methods>

Condensation time: In accordance with JIS R 5201 “Physical testing methods for cement”, the initiation time was measured (a formulation obtained by removing sand (ISO standard sand) from the formulation for a compression strength).

Compression strength: The compression strengths on the carbonation times of 1 day, and 3, 7 and 28 days were measured in accordance with JIS R 5201 “Physical testing methods for cement”.

Length variation rate: In accordance with JIS A 6202 “Expansive additive for concrete”, Annex B, the length variation rate at the age of 250 days was measured. However, the sample was form-released at 1 day after the casting, thereafter, aged in water for up to 7 days, and stored under an environment at an atmospheric temperature of 20° C. and a relative humidity of 60%.

TABLE 4

| | | | Compression strength | | | | | |
|---|---|---|---|---|---|---|---|---|
| | | Condensation | (N/mm²) | | | | Length | |
| | | time | carbonation time (B) | | | | variation | |
| | | (min) | 1 | 3 | 7 | 28 | rate (%) | Remarks |
| Admixture | γ-2CaO•SiO₂ | 185 | 12.4 | 18.4 | 28.8 | 48.3 | −0.051 | Example |
| A-1 | Li (in terms of | | | | | | | |
| | oxide): 0.002% | | | | | | | |
| Admixture | γ-2CaO•SiO₂ | 175 | 21.1 | 28.2 | 34.6 | 53.1 | −0.038 | Example |
| A | Li (in terms of | | | | | | | |
| | oxide): 0.1% | | | | | | | |
| Admixture | α-CaO•SiO₂ | 180 | 4.1 | 6.3 | 9.8 | 17.9 | −0.052 | Example |
| C-1 | Li (in terms of | | | | | | | |
| | oxide): 0.002% | | | | | | | |
| Admixture | α-CaO•SiO₂ | 175 | 7.0 | 9.4 | 11.5 | 19.1 | −0.037 | Example |
| C | Li (in terms of | | | | | | | |
| | oxide): 0.1% | | | | | | | |

### Experimental Example 5

In Experimental Example 4, Admixture A or Admixture A-1, or Admixture C or Admixture C-1 was each mixed with 100 parts of a cement so as to have the percentage shown in the following Table 5 to give a cement composition, and a mortal sample was prepared in accordance with JISR 5201 so as to have a water/cement composition ratio of 50% and a ratio of the cement composition to sand of 1:3 (mass ratio). At an age of 1 day, after mold release, a compression strength (after a carbonation time of 7 days) was measured in a similar manner to Experimental Example 4, except that accelerated carbonation curing was carried out on each under an environment of a temperature of 20° C., a relative humidity of 50% and a CO₂ concentration of 20% up to each age. The results are shown in the following Table 5.

Compression strength: A compression strength was measured in accordance with JIS R 5201 “Physical testing methods for cement”.

TABLE 5

| | | Compression strength at after | | | |
|---|---|---|---|---|---|
| | | 7 days of carbonation time | | | |
| | | (N/mm²) | | | |
| | | Content of admixture (parts) | | | |
| | | 25 | 50 | 70 | Remarks |
| Admixture A1 | γ-2CaO•SiO₂ | 28.8 | 32.2 | 33.0 | Example |
| | Li (in terms of oxide): 0.002% | | | | |
| Admixture A | γ-2CaO•SiO₂ | 34.6 | 39.4 | 40.3 | Example |
| | Li (in terms of oxide): 0.1% | | | | |
| Admixture C-1 | α-CaO•SiO₂ | 9.8 | 11.1 | 11.6 | Example |
| | Li (in terms of oxide): 0.002% | | | | |
| Admixture C | α-CaO•SiO₂ | 11.5 | 14.2 | 14.7 | Example |
| | Li (in terms of oxide): 0.1% | | | | |

### INDUSTRIAL APPLICABILITY

The present invention can be preferably used for a cement admixture used in the civil engineering and architecture fields, etc.

1. A cement admixture containing one kind or two or more kinds of non-hydraulic compound(s) selected from the group consisting of γ-2CaO·SiO₂, 3CaO·2SiO₂, α-CaO·SiO₂, and calcium magnesium silicate, wherein the non-hydraulic compound contains Li, and the content rate of the Li is 0.001 to 1.0% by mass in terms of oxide.

2. The cement admixture according to claim 1, which contains, as chemical components, 0.001 to 1.0 parts by mass of Li₂O, 45 to 70 parts by mass of CaO, 30 to 55 parts by mass of SiO₂, and 0 to 10 parts by mass of Al₂O₃ in 100 parts by mass of the cement admixture.

3. The cement admixture of claim 1, wherein the content rate of sulfur in the non-hydraulic compound is 1.0% by mass or less in terms of oxide.

4. The cement admixture of claim 1, wherein the content rate of the non-hydraulic compound is 70% by mass or more.

5. The cement admixture of claim 1, wherein the non-hydraulic compound is γ-2CaO·SiO₂.

6. The cement admixture of claim 1, wherein by-produced slaked lime is used as the CaO raw material for the non-hydraulic compound.

7. A cement composition, containing the cement admixture of claim 1.
